(19) United States
(12) Patent Application Publication
(10) Pub. No.: US 2026/0311155 A1
(43) Pub. Date: Oct. 8, 2026

(54) PEER-TO-PEER WAGERING SYSTEM FOR STAKES OF DISCREPANT VALUE

(71) Applicants: Tony Fontaine, Henderson, NV (US); Michael Staw, Westport, CT (US)

(72) Inventors: Tony Fontaine, Henderson, NV (US); Michael Staw, Westport, CT (US)

(21) Appl. No.: 19/634,607

(22) Filed: Mar. 31, 2026

Related U.S. Application Data
(60) Provisional application No. 63/780,984, filed on Mar. 31, 2025.

(51) Int. Cl. G06Q 20/20; G06Q 30/0601; G06Q 50/34; G07F 17/32

(52) U.S. Cl. CPC G06Q 20/203; G06Q 30/0641; G07F 17/3288; G06Q 50/34

(57) ABSTRACT

A system and method for facilitating peer to peer wagering using noncash stakes of differing value are disclosed. The system receives event data and odds data from an external data source and inventory data and pricing data from a POS system. Participant selections identifying goods or services as stakes are received from one or more client devices. A wager normalization engine generates a normalized wager data object by transforming the inventory data and the odds data to compute expected values associated with each participant and to enforce a constraint that a difference in expected value between participants remains within a predefined threshold. The system determines winning participants based on event results and initiates a fulfillment transaction with the POS system to provide one or more goods to the winning participant. The system may synchronize real time pricing and inventory data and automatically execute fulfillment through integrated transaction and delivery systems.

### CROSS-REFERENCE TO RELATED APPLICATIONS

This application claims the benefit of U.S. Provisional Patent Application No. 63/780,984 filed Mar. 31, 2025 entitled “PEER-TO-PEER WAGERING SYSTEM FOR STAKES OF DISCREPANT VALUE”, which is incorporated by reference herein in its entirety.

### FIELD OF THE INVENTION

The present disclosure relates to computerized systems for facilitating peer to peer interactions, and more particularly to systems and methods for normalizing heterogeneous value representations across distributed computing systems to enable automated transaction execution and fulfillment. In particular, the disclosure relates to systems that integrate wagering data, inventory data, and transaction systems to enable peer to peer exchanges using non cash stakes.

### BACKGROUND OF THE INVENTION

Wagering between individuals on the outcome of events has long been a popular social activity, often taking place in informal settings such as sports bars, restaurants, and private gatherings. Traditionally, these wagers have been conducted using cash as the primary medium of exchange, with participants agreeing on the terms of the bet and the amount at stake. In many cases, the wager is based on an honor system, where the losing party is expected to pay the winning party after the event concludes. However, this method is not without its shortcomings, as disputes over payment, delayed settlements, and concerns about fairness frequently arise.

The advancement of digital technology and the widespread adoption of mobile applications have led to the development of various online and mobile wagering platforms. These platforms enable users to place bets on sports events, casino-style games, and other competitions. While such platforms have automated the betting process and introduced regulatory compliance measures, they primarily rely on cash-based transactions. To participate, users must create accounts, undergo identity verification, and fund their accounts through credit cards, bank transfers, or other digital payment methods. This structure introduces friction in the form of registration requirements, delays in fund withdrawals, and additional fees imposed by operators.

In many social wagering scenarios, particularly those taking place in hospitality establishments such as bars and restaurants, participants often prefer to wager goods such as food, beverages, or merchandise instead of cash. This form of wagering enhances the social experience by integrating the wager into the broader context of shared entertainment. However, conventional wagering systems do not support such transactions, as they are designed for cash-based betting. Additionally, wagering goods of differing values presents a challenge, as traditional models assume an equal value of stakes between participants. In scenarios where one participant wagers an item of greater value than the other, the bet may be perceived as unfair or unbalanced, discouraging participation.

The absence of a structured, automated system for peer-to-peer wagering using non-monetary goods limits the potential for engagement in social wagering environments. Without a mechanism to account for discrepancies in stake values, participants must either manually negotiate terms or abandon wagers altogether. Additionally, there is no existing solution that seamlessly integrates with point-of-sale systems at establishments, enabling automatic fulfillment of wagered goods based on wager outcomes. The lack of such a system results in inefficiencies, missed opportunities for establishments to increase sales, and an overall limitation in how social wagering can be conducted.

Accordingly, there is a need for a solution that allows individuals to place peer-to-peer wagers using goods of discrepant value while ensuring fairness in the wagering process.

### BRIEF SUMMARY OF THE INVENTION

The present disclosure relates to systems, methods, and computer-readable media for facilitating peer-to-peer wagering using noncash stakes of differing value. A server system can receive wager selections from participant devices via a wagering application, event data and odds data from an external wagering data source, and inventory data and associated pricing data from a point-of-sale system. The system can generate a normalized wager data object by transforming the inventory data and the odds data to produce an expected value for each participant, wherein the transformation enforces a constraint that a difference in expected value between participants is within a predefined threshold. The normalized wager data object can be generated using real-time pricing data and can be dynamically updated based on changes in inventory data or pricing data prior to finalizing a wager, and the system can continuously or periodically synchronize inventory and pricing data with the point-of-sale system. In some implementations, the normalized wager data object can be generated by applying a probability distribution model, including a Gaussian distribution, to adjust a spread value associated with the event and to compute compensation values for one or more participants.

The system can finalize a wager based on the normalized wager data object, receive event results, and determine a winning participant. A fulfillment engine can initiate a transaction with the point-of-sale system to provide one or more goods selected as stakes to the winning participant, including automatically transmitting a purchase request upon determination of the winning participant, and can transmit fulfillment instructions to a third-party delivery service for delivery of the goods. The wagering application can present available goods and associated values retrieved from a goods and pricing database to users. The system can further support wagers involving a plurality of participants by aggregating wager selections and distributing expected value across the participants. The server system can record the normalized wager data object and associated fulfillment transaction in a transaction record. The disclosed functionality can be implemented in a system, a computer-implemented method, and a non-transitory computer-readable medium storing instructions that cause a processor to perform the described operations.

### BRIEF DESCRIPTION OF THE SEVERAL VIEWS OF THE DRAWINGS

The foregoing summary, as well as the following detailed description of embodiments of the system, will be better understood when read in conjunction with the appended drawings of an exemplary embodiment. It should be understood, however, that the invention is not limited to the precise arrangements and instrumentalities shown.

The FIGURE is a block diagram illustrating the components of a peer-to-peer (P2P) wagering system, including the mobile wagering application, web server, sports and wager server, goods and pricing database, wager equalizer module, outcome determination server, and Point-of-Sale (POS) integration module, in accordance with an embodiment of the present disclosure.

### DETAILED DESCRIPTION OF THE EXEMPLARY EMBODIMENTS OF THE INVENTION

Non-limiting definitions of one or more terms utilized in this disclosure are provided below. It is understood that the definitions are provided for the sake of clarity and are intended to include more examples than just provided below.

Peer-to-Peer (P2P) Wagering System-A system enabling two or more participants to place wagers using non-cash stakes, such as food, beverages, or merchandise, rather than traditional currency. The system facilitates wager placement, normalization of stake values, outcome determination, and wager settlement.

Wager Equalizer Module—A computational module that applies risk-adjusted calculations, including point spreads, moneyline odds, and probabilistic models, to normalize wagers when participants stake goods of differing monetary values.

Mobile Wagering Application—A software application installed on a participant's device, such as a mobile device, that provides an interface for selecting wagerable goods, constructing wagers, submitting bets, tracking wager status, and receiving outcome notifications.

Web Server—A network-connected computing system that facilitates secure communication between participants, the mobile wagering application, and backend system components, enabling real-time wager processing and data exchange.

Sports and Wager Server—A processing server that retrieves sports event data, odds, point spreads, and moneyline values from an Advance Deposit Wagering operator, maintains a database of active wagers, and updates wager terms dynamically based on real-time event data.

Advance Deposit Wagering (ADW) Operator—A licensed wagering entity that collects and disseminates sports betting data, processes wagers, determines event outcomes, and ensures compliance with applicable regulatory and gambling laws.

Goods and Pricing Database—A dynamically updated database storing available wagerable goods and their corresponding prices, retrieved from an inventory system, such as a third party's inventory system, via a Goods and Price API, ensuring accurate pricing and availability.

Outcome Determination Server—A backend processing unit that retrieves event results from the ADW operator, determines the winning participant, and triggers payment processing and fulfillment of the wagered goods.

POS Integration Module—A system interface that connects the P2P wagering system with an establishment's POS system, enabling automated payment processing, wager settlement, and order fulfillment through an integrated POS API.

Gamification Module-A system feature that tracks participant wager history, awards points, maintains leaderboards, and facilitates contests, enhancing user engagement and incentivizing continued participation.

Third-Party Fulfillment Service—A delivery service, such as UberEats or DoorDash, integrated into the system to enable remote fulfillment of wagered goods, allowing participants in different locations to place and settle wagers while receiving their winnings via delivery.

Referring to the drawing in detail, there is shown in the FIGURE a system in accordance with an exemplary embodiment of the present invention. In some embodiments, the system is configured to generate a normalized wager data object, which comprises a structured data representation including participant identifiers, selected goods or services, corresponding pricing data, event data, odds data, and computed expected values associated with each participant. The normalized wager data object is generated by transforming heterogeneous inputs received from multiple external systems into a unified machine-readable structure that is used to process, store, and execute wagers.

The system is configured to receive and process multiple categories of data including event data and odds data received from an external wagering data source, inventory data and pricing data received from a POS system, and participant selections received from one or more client devices. These data sources may operate independently and may be subject to differing update frequencies, data formats, and latency constraints. The system integrates these disparate inputs into a unified processing pipeline that enables consistent and reliable wager construction.

A wager normalization engine is configured to transform the received data into the normalized wager data object by mapping goods and services to corresponding value representations, computing expected values based on odds data, and applying a normalization constraint such that a difference in expected value between participants remains within a predefined threshold. In some embodiments, the normalization engine further computes adjusted values or compensation values to reconcile differences between participant stakes.

In some embodiments, the normalized wager data object comprises a structured data record including multiple fields that are generated and updated by the wager normalization engine. By way of example, the normalized wager data object may include a participant field identifying each participant, a stake field identifying one or more goods or services selected by each participant, a pricing field including pricing data associated with each selected good or service, an event field including event data and associated odds data, an expected value field including computed expected values for each participant based on the odds data, a normalization constraint field defining a permitted difference in expected value between participants, and a fulfillment field identifying one or more goods to be provided upon determination of a winning participant. The normalized wager data object may further include a status field indicating a state of the wager and a transaction field storing data associated with fulfillment of the wager. The structured data record is configured to be stored in memory and transmitted between system components to enable processing, validation, and execution of the wager.

The P2P wagering system may enable participants to place wagers using non-cash stakes of discrepant value, such as food, beverages, or merchandise. Unlike conventional wagering systems that rely on cash-based betting, the system may provide a novel wager equalization mechanism that ensures fairness by applying risk-adjusted calculations, including moneyline odds and point spreads, to normalize stakes of differing values.

The transformation performed by the wager normalization engine converts heterogeneous data inputs into a unified computational representation that enables automated processing. In particular, the system maps inventory-based goods to value representations using pricing data and computes expected value using odds data associated with an event. This transformation enables disparate value sources to be reconciled within a single data structure that can be used to finalize a wager.

In some embodiments, the wager normalization engine applies a probability distribution model to compute expected values and adjust wager parameters. For example, a Gaussian distribution may be used to model variability in event outcomes, and a spread value associated with the event may be adjusted based on statistical parameters. Expected values may be computed using probabilistic functions derived from the odds data, thereby enabling dynamic adjustment of wager parameters while maintaining the normalization constraint.

The normalization process enables the system to enforce fairness in a quantifiable manner by constraining differences in expected value between participants. This allows wagers involving noncash stakes of differing value to be processed in a manner that is consistent and repeatable across different system conditions.

The system may include a mobile wagering application, which allows participants to construct, submit, and track wagers in real-time. The application interfaces with a web server that facilitates communication between system components, including a sports and wager server that retrieves real-time event data, odds, and betting lines from an ADW operator. The system also includes a goods and pricing database that dynamically updates available wagerable goods and their prices based on an establishment's inventory.

Upon wager placement, an outcome determination server retrieves the event results from the ADW operator, determines the winning participant, and initiates wager settlement. A POS integration module processes payment from the losing participant and facilitates the purchase and delivery of wagered goods to the winner, either on-site at an establishment or remotely via a third-party fulfillment service.

Additionally, the system incorporates gamification features, including leaderboards, wager history tracking, and contests, enhancing participant engagement. The invention provides a seamless, automated, and socially interactive wagering experience, eliminating the need for traditional cash-based transactions while ensuring compliance with regulatory and wagering laws.

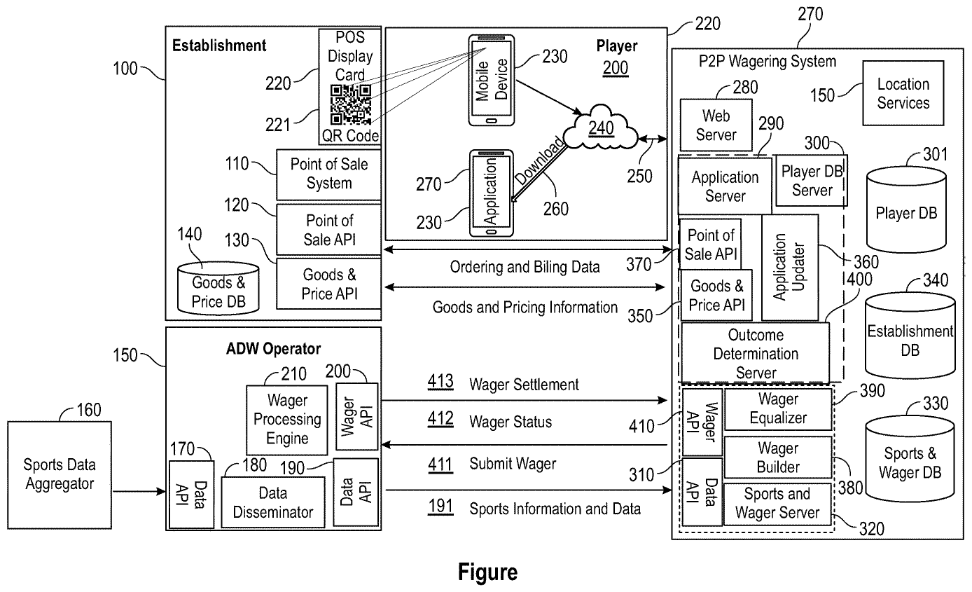

FIG. 1 illustrates the architecture and operational flow of a P2P wagering system 270, which enables participants 200 to place wagers on sporting events or other competitions using goods of discrepant value instead of cash. The system 270 integrates multiple key components, including mobile applications 230, database servers 300, 330, 340, an application server 290, an external ADW Operator 150, and a POS system 110 at an establishment 100. Through a wager equalizer 390, the system 270 ensures that despite differences in the monetary value of wagered goods, the stakes remain equitable between both participants. This is achieved via a risk-adjustment algorithm that dynamically modifies the value of the wager while maintaining the integrity of the wager. The system architecture comprises multiple interconnected APIs, databases, servers, and processing engines, which collectively manage wager placement, real-time odds retrieval, outcome determination, and order fulfillment.

The system is further configured to synchronize data across multiple external systems to ensure consistency during wager construction. In some embodiments, inventory data and pricing data are continuously updated from the POS system, and event data and odds data are periodically refreshed from the external wagering data source. The system may verify the accuracy of the data prior to finalizing a wager to ensure that the normalized wager data object reflects current system conditions.

Synchronization may occur at predefined intervals, in response to data update events, or upon initiation of a wager. By maintaining synchronized data across distributed systems, the system reduces inconsistencies that may otherwise arise due to latency or asynchronous updates. In some embodiments, the system delays finalization of a wager until confirmation of pricing data is received from the POS system. This ensures that the values used in the normalization process correspond to available inventory and current pricing conditions.

Each player 200 may interact with the system through an application, such as a mobile application 230, installed on their mobile device or accessible via a computer. The application 230 serves as an interface for constructing wagers, selecting goods, and communicating with the wagering platform. The player 200 may scan a quick response (QR) Code 221 located on a POS display card 220 at the establishment 100 to directly access the P2P wagering system 270. This interaction occurs over the internet 240, where a web server 280 facilitates the application 230 downloads and wager processing. Once installed, the mobile application 230 enables users to browse goods and pricing information retrieved from the Goods & Price Database 140 maintained by the establishment 100. This pricing data is continuously updated and transmitted via the Goods and Price API 130 of the POS system 110 to the P2P wagering system 270 through its corresponding Goods and Price API 350. These updates are managed by an application updater 360 to ensure that establishment DB 340 remains up to date. To engage in wagering, the player 200 selects goods as the wager stake, chooses a sports event, and constructs a bet. Player database server 300 stores the player's registration details and maintains a record of their wager history.

The establishment 100 provides the goods that serve as stakes in wagers. These goods and their prices are listed in the Goods and Price Database 140, which is continuously synchronized with the P2P wagering system 270 via the Goods and Price API 130. This ensures that players have real-time access to an up-to-date menu. Upon wager completion, the system 270 communicates order and billing details to the Point of Sale API 120, which is linked to the POS system 110. This integration facilitates the automatic fulfillment of wagered goods and ensures that the losing participant is billed accordingly. The wagered goods are then delivered to the winning player either at the establishment or through a third-party delivery service.

The P2P wagering system 270 may include multiple interconnected components responsible for processing wagers and determining their outcomes. The application server 290 manages user requests, wager submissions, and system-wide communications. The sports and wager server 320 retrieves sports-related data, such as betting odds and game statistics, from the ADW operator 150 via the wager API 310. The sports and wager DB 330 stores all historical and real-time wagering data, ensuring that the most current information is available to users. A critical component in the system 270 is the outcome determination server 400, which is responsible for processing wagers and determining their results. This is accomplished through a wager builder 380 and the wager equalizer 390. The wager builder 380 formats the wager based on the ADW operator 150's requirements. The wager equalizer 390 dynamically adjusts wagers when players stake goods of differing values. This proprietary algorithm ensures that the value of the wager remains fair and balanced. Once the wager is equalized, it is transmitted via the wager API 410 to the ADW operator 150 for official recording and grading.

The ADW operator 150 may provide sports betting data and official wager outcomes. It receives sports data from the sports data aggregator 160 through the data API 170. This data is processed by the data disseminator 180 and sent to the P2P wagering system 270 via the data API 310. The ADW operator 150 determines the results of the wager through its wager grading engine 210. Once an event concludes, the wager grading engine 210 evaluates the outcome and transmits the graded wager through the wager API 420 back to the P2P wagering system 270. The outcome determination server 400 processes the result and updates the application server 290, which notifies the participants of the wager's outcome.

The system 270 may equalize wagers when players stake goods of different values. The wager equalizer 390 ensures fairness using a mathematical approach. The system 270 retrieves betting odds and point spreads from the ADW operator 150 and averages them across bookmakers. It adjusts these odds to remove the bookmaker's vig (commission). Given these adjusted odds, the system 270 computes the probability (p) of each participant winning the wager, considering both moneyline odds and the implied value of the wagered goods. To ensure fair risk allocation, the system 270 applies a point spread adjustment using a Gaussian probability distribution function expressed as

$$f ( x ) = \frac{1}{σ \sqrt{2 π}} {e}^{- \frac{1}{2} {( \frac{x - μ}{σ} )}^{2}}$$

where x represents the adjusted point spread, μ is the consensus point spread value, and σ is the standard deviation of the distribution. The system then integrates this function to determine the cumulative probability distribution as:

$$Φ ( x ) = \frac{1}{2} [ 1 + \frac{2}{\sqrt{π}} {\int }_{0}^{\frac{x}{\sqrt{2}}} {e}^{- {t}^{2}} dt ]$$

Since Φ(x) is equal to the cumulative probability that the final score will be less than (x), and the mean is defined to be 0, it can be now equated the probability to win, as derived from the money line to be equal to the probability to win as calculated by the consensus points line (adjusted for points). This can be made equivalent by relying on the quality and experience of the line makers.

This ensures that the implied probability from the wagered goods matches the actual probability derived from betting odds. The final wager adjustment is incorporated by the wager builder 380, which formats the adjusted wager before sending it to the ADW operator 150 for official processing.

Once the wager is graded, the P2P wagering system 270 automatically updates the application server 290 to notify participants of the wager result. It generates an order request via the Point of Sale API 370 to the establishment's POS system 110. It bills the losing participant and ensures the fulfillment of wagered goods to the winner. This seamless integration between the wagering platform, establishment, and ADW Operator ensures a frictionless experience for players, making this system an innovative alternative to traditional P2P sports betting.

In some embodiments, the system includes a fulfillment engine configured to automatically execute a transaction based on the outcome of the wager. Upon determining a winning participant, the system generates a fulfillment request identifying one or more goods associated with the normalized wager data object and transmits the request to a POS system to initiate a transaction.

The fulfillment process may further include communicating with a third party delivery service to facilitate delivery of goods to the winning participant. The system may generate delivery instructions and transmit such instructions to the delivery service based on participant location and selected fulfillment options.

In one illustrative embodiment, the system is implemented in a bar or restaurant environment in which the POS system maintains inventory data for food and beverage items. In such an embodiment, participants may select menu items as stakes using a client device executing the wagering application, and the system retrieves corresponding pricing data from the POS system. The wager normalization engine generates a normalized wager data object based on the selected menu items and event data associated with a sporting event. Upon completion of the event, the system determines a winning participant and automatically transmits a fulfillment request to the POS system to prepare and provide the selected food or beverage items to the winning participant. In some embodiments, the system may integrate with existing restaurant POS platforms to retrieve real time pricing and inventory availability and to initiate order fulfillment without requiring manual input by restaurant staff.

The system may store a transaction record associated with each wager, wherein the transaction record includes the normalized wager data object, outcome data, and fulfillment data. This enables tracking and verification of wager execution and fulfillment.

FIG. 1 presents a P2P wagering system 270 that enables players to wager using goods instead of cash. The system 270 ensures real-time odds retrieval, automatic wager equalization, risk-adjusted outcomes, and direct POS fulfillment. By leveraging mathematical modeling and API-driven integrations, the system creates a novel and compliant peer-to-peer sports wagering platform. The architecture is designed to maintain fairness, security, and compliance with gaming regulations while providing a dynamic and engaging wagering experience for users. The use of goods rather than cash for betting stakes introduces a unique aspect to P2P wagering, making the system particularly well-suited for social settings such as sports bars, restaurants, and online communities where users prefer non-cash-based betting engagements. The integration with third-party food delivery services allows users to participate remotely, extending the functionality beyond physical establishments. The wager equalizer 390 adjusts different wager values dynamically to provide a fair betting experience. By offering a combination of automated settlement, seamless establishment integration, and compliance with ADW regulations, the P2P wagering system 270 redefines how participants engage in social wagering.

The P2P wagering system 270 improves the functionality, efficiency, and user experience of peer-to-peer wagering. For example, the system improves wager equalization algorithms, real-time sports data integration, automated wager settlement, secure and frictionless transactions, regulatory compliance, and expanded accessibility through integration with establishments' POS systems and third-party fulfillment services. The system provides a novel wagering platform that removes traditional barriers associated with cash-based P2P betting while maintaining fairness and compliance in a structured, automated manner.

One feature of the system is the implementation of the wager equalizer 390, which dynamically adjusts wager values when participants stake goods of differing monetary worth. Unlike traditional betting systems, which require equal monetary wagers from both participants, the system incorporates an algorithmic approach to balance the stakes, ensuring fairness without requiring manual calculations by the players. This is accomplished through real-time analysis of betting odds and point spreads retrieved from the ADW operator 150. By applying statistical modeling techniques, including Gaussian probability distributions, the system determines an appropriate adjustment in point spread or payout odds, ensuring that both players are wagering under conditions of equal expected value. The real-time nature of this equalization system allows dynamic modifications before wager confirmation, ensuring that last-minute changes in goods selection or event odds are accurately reflected in the final wager terms.

The system may integrate real-time sports data. The P2P wagering system 270 connects to the ADW Operator 150, which retrieves live sports data from the sports data aggregator 160 via the data API 170. This data may include wagering information such as point spreads, moneyline odds, team and player statistics, and event status updates. The P2P wagering system 270 processes and stores this data in the sports and wager DB 330, ensuring that all displayed odds and betting propositions are up to date. This continuous synchronization eliminates the possibility of outdated betting lines, allowing for real-time bet placement with the most accurate market data. Furthermore, the sports and wager server 320 communicates with the outcome determination server 400 to analyze event results, ensuring rapid grading of wagers upon event conclusion. Unlike conventional P2P betting systems that rely on manually input or static odds, this invention provides a fully automated, data-driven approach to wager creation, verification, and settlement.

The system provides automated wager settlement and fulfillment. In traditional P2P betting, settlement often requires manual confirmation of the bet's outcome, verification of payment, and distribution of winnings. The P2P wagering system 270 eliminates these inefficiencies by integrating directly with the ADW operator 150 for automated wager grading and with the establishment 100 for automatic, and sometimes instant, prize fulfillment. Upon wager placement, the system automatically records the stake selection in the goods & price database 140 and ensures that billing information is prepared in advance through the POS API 120. When the event concludes, the ADW operator's wager grading engine 210 determines the outcome and transmits the results to the outcome determination server 400 via the wager API 420. This information is then relayed to the application server 290, which updates the participants on the result while simultaneously triggering the order fulfillment process. The winning player receives their wagered goods automatically, and sometimes instantly, while the losing player is automatically billed through the POS system 110, reducing disputes and eliminating settlement delays.

Traditional P2P betting platforms require users to establish and fund accounts before placing wagers, typically through an ADW model. This requires extensive identity verification, payment processing, and manual withdrawals, introducing delays and friction into the betting experience. The P2P wagering system 270 circumvents these limitations by leveraging direct POS integration for wager settlement. The system 270 does not require players to maintain an account balance, as the cost of the wagered goods is processed at the moment of bet confirmation. By integrating with an establishment's existing POS system, the P2P wagering system 270 ensures that losing players are charged directly through their selected payment method, while winners receive their prizes automatically. This architecture dramatically reduces the time and effort required for wager processing and payout, enhancing the user experience and making P2P wagering as simple as placing an order at a restaurant.

The system may provide compliance with governmental or other third party regulations. Traditional P2P betting is often subject to strict legal and financial regulations, requiring operators to maintain compliance with anti-money laundering (AML) laws, Know Your Customer (KYC) requirements, and responsible gaming practices. The P2P wagering system 270 ensures compliance by integrating with a licensed ADW operator 150 for event grading and wager validation. Since the system 270 processes wagers using goods instead of cash, it inherently reduces the risks associated with money laundering while maintaining a secure transactional environment. The use of establishment-based POS transactions ensures that all financial transactions are traceable, preventing fraudulent activity and ensuring transparency. Additionally, the system 270 employs geolocation and user verification techniques to ensure that wagering activity occurs within legally approved jurisdictions. Unlike conventional betting platforms that require users to undergo extensive registration and fund transfer processes, this system 270 leverages existing payment infrastructure while maintaining full compliance with gaming regulations.

Accessibility and scalability are provided through the system's integration with third-party fulfillment services. While traditional P2P betting typically requires participants to be physically present in the same location, the P2P wagering system 270 expands this model by allowing remote participation. The system 270 is designed to integrate with food and beverage delivery platforms such as UberEats and DoorDash, enabling users to wager on goods even if they are not in the same establishment. By incorporating third-party APIs, the system ensures that wagered goods can be delivered directly to the winning player, further broadening the use cases for P2P wagering. This capability extends the system's reach beyond social establishments to include online and remote interactions, making it an ideal solution for digital-first betting experiences.

The system may support gamification features that enhance user engagement. The P2P wagering system 270 allows participants to create structured wagering contests involving multiple events and outcomes. Users can track their betting performance, accumulate points based on wager success, and participate in leaderboard rankings. This gamification framework transform PSP wagering from a simple bet-settlement model into an interactive social experience. Unlike traditional sportsbook betting, which is transactional in nature, this system fosters ongoing user engagement by introducing competitive and reward-based mechanics.

The integration of AI-driven analytics within the system may provide users with data-driven insights and recommendations. The Wager Equalizer 390 not only balances wagers but can also suggest optimal wager adjustments based on historical betting data, player preferences, and real-time market conditions. By leveraging machine learning models, the system can identify trends in betting behavior, optimize point spreads dynamically, and offer personalized betting opportunities. This predictive analytics capability enhances the fairness of P2P wagering while maximizing user satisfaction by ensuring balanced and competitive bet structures.

Traditional P2P betting carries inherent risks such as wager disputes, non-payment issues, and fraudulent activity. The P2P Wagering System 270 mitigates these risks by implementing a secure, automated transaction pipeline that ensures wager verification, payment processing, and fulfillment occur seamlessly. By eliminating manual intervention and leveraging API-based automation, the system ensures that all wagers are processed in a secure and transparent manner. Additionally, the use of encrypted communication channels and secure authentication mechanisms ensures that user data and financial transactions remain protected from unauthorized access.

The P2P wagering system 270 enhances fairness, efficiency, security, and accessibility. Through the implementation of real-time wager equalization, automated settlement, seamless POS integration, regulatory compliance mechanisms, and AI-driven analytics, the system offers social betting. Unlike conventional P2P betting models that rely on static odds, manual settlement, and cash-based transactions, this system leverages cutting-edge technology to provide a frictionless, automated, and fully compliant wagering experience.

In some embodiments, the system supports wagers involving more than two participants. In such embodiments, participant inputs are aggregated, and expected value is computed across all participants. The normalization constraint is applied collectively to ensure that the distribution of expected value remains within a predefined threshold across the group.

The system may further be configured to detect inconsistencies in pricing data or inventory data and to recalculate the normalized wager data object in response to such changes prior to finalizing a wager. In some embodiments, wagers that fail to satisfy the normalization constraint are rejected or modified to ensure compliance with system requirements.

The disclosed system provides a technical solution for transforming heterogeneous data sources into a unified computational representation and synchronizing distributed systems with differing data characteristics. By enabling automated execution of transactions based on computed outcomes, the system improves the operation of distributed computing systems by reducing latency, improving data consistency, and enabling automated fulfillment without manual intervention.

In one embodiment, the system includes one or more computers having one or more processors and memory (e.g., one or more nonvolatile storage devices). In some embodiments, memory or computer readable storage medium of memory stores programs, modules and data structures, or a subset thereof for a processor to control and run the various systems and methods disclosed herein. In one embodiment, a non-transitory computer readable storage medium having stored thereon computer-executable instructions which, when executed by a processor, perform one or more of the methods disclosed herein.

Aspects of the present disclosure are not limited to the exemplary structural details and component arrangements described in this description and shown in the accompanying drawings. Many aspects of this disclosure may be applicable to other aspects and/or capable of being practiced or carried out in various variants of use, including the examples described herein. It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Unless specifically set forth herein, the terms “a”, “an” and “the” are not limited to one element but instead should be read as meaning “at least one”. Inclusive terms such as “comprises,” “comprising,” “includes,” “including,” and variations thereof, are intended to cover a non-exclusive inclusion, such that aspects of any apparatus, kit, method, and system described herein, or element(s) thereof described as comprising a list of elements does not include only those elements but may include other elements not expressly listed and/or inherent thereto. Unless stated otherwise, the term “exemplary” means “example” rather than “ideal.” Various terms of approximation may be used, including “approximately” and “generally.” Approximately means “roughly” or within 10% of a stated number or outcome and generally means “usually” or more than a 50% probability of a stated number or outcome.

It will be appreciated by those skilled in the art that changes could be made to the exemplary embodiments shown and described above without departing from the broad inventive concepts thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and various features of the disclosed embodiments may be combined.

To the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

I/We claim:

1. A system for facilitating peer-to-peer wagering using stakes of differing value, the system comprising:
a server system comprising at least one processor and memory storing instructions, the server system configured to receive a wager from at least one participant via a wagering application;
a goods and pricing database storing inventory data and associated pricing data received from a point of sale system;
a sports data interface configured to receive event data and odds data from an external wagering data source;
a wager normalization engine executed by the server system and configured to generate a normalized wager data object by transforming the inventory data and the odds data to produce an expected value for each of at least two participants, wherein the transformation enforces a constraint that a difference in expected value between the participants is within a predefined threshold;
an outcome processing engine configured to receive event results and determine a winning participant based on the event results; and
a fulfillment engine configured to initiate a transaction with the point-of-sale system to provide one or more goods to the winning participant based on the normalized wager data object.

2. The system of claim 1, wherein the wager normalization engine applies a probability distribution model to determine the expected value for each participant.

3. The system of claim 2, wherein the probability distribution model comprises a Gaussian distribution to adjust a spread value associated with the event.

4. The system of claim 1, wherein the wager normalization engine generates the normalized wager data object using real time pricing data received from the point-of-sale system prior to finalizing a wager.

5. The system of claim 1, wherein the fulfillment engine is configured to automatically transmit a purchase request to the point-of-sale system upon determination of the winning participant.

6. The system of claim 1, wherein the server system is configured to continuously synchronize the inventory data and pricing data with the point-of-sale system to account for inventory changes.

7. The system of claim 1, wherein the wagering application is configured to present available goods and associated values retrieved from the goods and pricing database to a user.

8. The system of claim 1, wherein the system further comprises a delivery interface configured to transmit fulfillment instructions to a third-party delivery service.

9. The system of claim 1, wherein the wager normalization engine is further configured to generate the normalized wager data object for a plurality of participants participating in a single wager.

10. The system of claim 1, wherein the server system is configured to record the normalized wager data object and the fulfillment transaction in a transaction record associated with the wager.

11. A computer implemented method for facilitating peer to peer wagering using noncash stakes of differing value, the method comprising:
receiving, at a server system, event data and odds data from an external wagering data source;
receiving inventory data and pricing data from a point-of-sale system;
receiving wager selections from at least two participant devices, each wager selection including one or more goods selected as a stake;
generating a normalized wager data object by transforming the inventory data and the odds data to produce an expected value for each participant, wherein the transformation enforces a constraint that a difference in expected value between the participants is within a predefined threshold;
finalizing a wager based on the normalized wager data object;
receiving event results corresponding to the event data;
determining a winning participant based on the event results; and
initiating a fulfillment transaction with the point-of-sale system to provide one or more goods to the winning participant.

12. The method of claim 11, wherein generating the normalized wager data object comprises applying a probability distribution model to compute a compensation value for at least one participant.

13. The method of claim 12, wherein the probability distribution model comprises adjusting a spread value based on a Gaussian distribution.

14. The method of claim 11, further comprising updating the normalized wager data object based on changes in the inventory data or pricing data prior to finalizing the wager.

15. The method of claim 11, further comprising synchronizing the inventory data with the point-of-sale system at predefined time intervals.

16. The method of claim 11, further comprising transmitting a fulfillment request to a third-party for delivery of the goods to the winning participant.

17. The method of claim 11, wherein generating the normalized wager data object comprises aggregating wager selections from a plurality of participants and distributing expected value across the plurality of participants.

18. A non-transitory computer readable medium storing instructions that, when executed by a processor, cause the processor to:
receive event data and odds data from an external wagering data source;
receive inventory data and pricing data from a point-of-sale system;
receive wager selections from at least two participant devices;
generate a normalized wager data object by transforming the inventory data and the odds data to produce an expected value for each participant, wherein a difference in expected value between the participants is constrained within a predefined threshold;
determine a winning participant based on event results; and
initiate a fulfillment transaction with the point-of-sale system to provide one or more goods to the winning participant.

19. The non transitory computer readable medium of claim 18, wherein the instructions further cause the processor to apply a probability distribution model to adjust a spread value associated with the event.

20. The non transitory computer readable medium of claim 18, wherein the instructions further cause the processor to dynamically update the normalized wager data object based on real time pricing data.
